(19) United States
(12) Patent Application Publication
(10) Pub. No.: US 2008/0175234 A1
(43) Pub. Date: Jul. 24, 2008

(54) METHOD AND DEVICE FOR PROTECTIVE SWITCHING OF PSEUDO-WIRES ON PACKET SWITCHING NETWORK

(75) Inventor: Xixiang LI, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/956,504

(22) Filed: Dec. 14, 2007

Related U.S. Application Data
(63) Continuation of application No. PCT/CN2006/001349, filed on Jun. 15, 2006.

(30) Foreign Application Priority Data
Sep. 30, 2005 (CN) 200510107438.0

(51) Int. Cl. H04L 12/56

(52) U.S. Cl. 370/389

(57) ABSTRACT

The present invention provides a method and device for protective switching of pseudo-wires on a Packet Switching Network. The method includes grouping the pseudo-wires on the Packet Switching Network into a working pseudo-wire group and a protective pseudo-Wire group corresponding to each other's relationship of protection; performing on services the protective switching between the working pseudo-wire group and the protective pseudo-wire group according to the state of the working pseudo-wire group and protective pseudo-wire group. The method of the present invention can be used to perform edge-to-edge grouped protective switching of the pseudo-wires on the Packet Switching Network.

### CROSS-REFERENCE TO RELATED APPLICATIONS

The present application is a continuation of PCT Application No. PCT/CN2006/001349, filed on Jun. 15, 2006, which claims priority to Chinese Patent Application No. 200510107438.0, filed on Sep. 30, 2005. All of these applications are incorporated herein by reference for all purposes.

### FIELD OF THE INVENTION

The present invention relates to the field of communications, and more particularly, to a method and device for protective switching of pseudo-wires (PWs) on a Packet Switching Network (PSN).

### BACKGROUND OF THE INVENTION

Several standards for Pseudo-Wire Emulation were defined in the Internet Engineering Task Force Pseudo-Wire Emulation Edge-to-Edge working group (IETF PWE3 WG). According to the principle of the PWE3, an edge-to-edge tunnel is created for transporting various original Layer 1 and Layer 2 services, which include Asynchronous Transfer Mode (ATM), Ethernet, Frame Relay, High level Data Link Control (HDLC)/Peer-to-Peer Protocol (PPP), Integrated Services Digital Network (ISDN), Synchronous Digital Hierarchy (SDH)/Synchronous Optical Network (SONET), etc. The PWE3 assures all of the Quality of Service (QoS) required for the various services being transported.

In practical applications, for the purpose of enabling PWs to be common across multiple carriers and reducing the number of tunnels, stitching and switching of PWs are required. Such PWs are called multi-segment pseudo-wires (MS-PWs), which are specified by the relevant draft standards in IETF PWE3 WG. The PWs that are not required to be switched and stitched are called single-segment pseudo-wires (SS-PWs).

Generally, PWs bear private line services. Such as for banks, securities markets, and enterprises, relatively important private lines need to be protected on PSNs. However, the PW protection standard is not defined in standards organizations, such as IETF PWE WG, ITU-T, Metro Ethernet Forum (MEF) and Multiprotocol Label Switching/Frame Relay/Asynchronous Transfer Mode Alliance (MFA).

According to a method for protective switching of PWs in the prior art, PWs are indirectly protected through the protection of each segment of tunnels. If a PW fails within a certain segment of a tunnel, the protection of the segment of the tunnel, i.e., the switching of all of the PWs within the segment of the tunnel, will be performed. In this case, one failed PW will result in the simultaneous switching of all of the PWs within the segment of the tunnel. As a result, the switching efficiency is not high, and the switching of some good working PWs may be wrongly performed. If a fault occurs in protective connections for a certain PW, which cannot be isolated from other PWs by the protective switching, it results in the interruption of the services on the PW and the repeating fluctuation during the protective process of the PW, even network paralysis.

According to another method for protective switching of PWs in the prior art, for each PW, a working PW and a protective PW are configured. The system monitors each of the working PWs and each of the protective PWs. If a working PW fails, the system starts the protective switching mechanism to switch the service to a protective PW. If the method is adopted, the system is required to monitor each of the PWs, thereby laying a heavy burden on the system and degrading the system performance. Moreover, if the number of failed PWs is large, the switching speed will be greatly reduced and the switching time will exceed the maximum switching time allowed by the communications network, e.g., 50 ms. Therefore, the QoS is degraded.

### SUMMARY OF THE INVENTION

The embodiments of the present invention provide not only a method for protective switching of PWs on a PSN, but also a device for protective switching of PWs on a PSN, which solves the problems of edge-to-edge protective switching of PWs on an existing PSN.

The technical solutions of the present invention include:

A method for protective switching of PWs on a PSN, in which the PWs on the PSN are grouped into a working PW group (PWG) and a protective PW group corresponding to each other according to a preset criterion, the method further includes:

Monitoring the state of the working PWG and the protective PWG, and performing on services the protective switching between the working PWG and the protective PWG when it is determined that a protective switching condition is met.

One-to-one mapping is established between the PWs in the working PWG and the PWs in the protective PWG according to an order in which the PWs are arranged in the two PWGs respectively.

The preset criterion includes, but is not limited to, the same source and destination, the same path, the same type and the same QoS requirement, or a criterion specified according to transmission requirements.

The PW in the working PWG and the protective PWG is a single-segment PW or a multi-segment PW.

One or more PWs are contained in the working PWG and the protective PWG.

It is determined that the protective switching condition is met, if a monitored PW in a PWG is in Local Transmit Fault (LTF) state and/or Local Receive Fault (LRF) state, and a PW state corresponding to the monitored PW in the other PWG is in a normal state.

The LTF state and the LRF state may be generated by a transmit fault or an interface fault occurring in a PW forwarder on a source provider edge (PE) or a destination provider edge or generated by the server layer of the PW.

It is determined that the protective switching condition is met, if a normal session of the (Virtual Circuit Continuity Verification) VCCV performed for the monitored PW in a PWG has not been established within a prescribed period of time, and the PW corresponding to the monitored PW in the other PWG is in a normal state.

The protective switching performed between the working PWG and the protective PWG can be 1+1, 1:1 or 1:N, unidirectional or bidirectional, recoverable or unrecoverable, manual, or of a mode defined by (Automatic Protective Switching) APS protocols.

A device for protective switching of PWs on a PSN includes:

a grouping unit for grouping PWs on a PSN into a working PWG and a protective PWG corresponding to each other according to a preset criterion;

a PW state monitoring unit for monitoring the state of the working PWG and the protective PWG, and for sending signals to the protective switching unit when it is determined that a protective switching condition is met;

a protective switching unit for performing on services the protective switching between the working PWG and the protective PWG according to the received signals.

One-to-one mapping is established between the PWs in the working PWG and the PWs in the protective PWG according to an order in which the PWs are arranged in the two PWGs, respectively.

The preset criterion includes, but is not limited to, the same source and destination, the same path, the same type and the same QoS requirement, or a criterion specified according to transmission requirements.

The PW in the working PWG and the protective PWG is a single-segment PW or a multi-segment PW.

One or more PWs are contained in the working PWG and the protective PWG.

The protective switching performed between the working PWG and the protective PWG can be 1+1, 1:1 or 1:N, unidirectional or bidirectional, recoverable or unrecoverable, manual, or of a mode defined by Automatic Protective Switching (APS) protocols.

It can be seen from the above technical solutions provided by the present invention that, through the grouping of PWs according to a criterion, such as the same source and destination, the same path, the same type and the same QoS requirement, one-to-one mapping is established between the PWs in the working PWG and the PWs in the protective PWG; when a fault occurs in the working PWG, the services on the working PWG can be switched onto the protective PWG. The protective switching is performed only for a desired group, thereby enabling the edge-to-edge grouped protective switching of the PWs on the PSN, so that the problem of edge-to-edge protective switching of PWs on an existing PSN is solved.

As mentioned above, the protective switching operation according to an embodiment of the invention is determined according to the monitoring results, and the protective switching is performed only for the PWG in which the protective switching condition is met. As a result, the simultaneous switching of all of the PWs within a tunnel due to one failed PW can be avoided and the switching efficiency can be improved. Also, the wrong switching of normal PWs and repeating oscillation of the protective switching are avoided.

Further, the system need not monitor each working PW and each protective PW, therefore avoiding laying a heavy burden on the system and degrading the system performance. As a result, the switching speed will be increased and the switching time will not exceed the maximum switching time allowed by the communications network. Therefore, the QoS is improved.

### BRIEF DESCRIPTION OF THE DRAWINGS

FIG. 1 is a processing flowchart according to one particular embodiment of the method of the present invention;

FIG. 2 is a schematic diagram illustrating a reference model of a MS-PW defined in an IETF draft standard;

FIG. 3 is a schematic diagram illustrating the network connections in the reference model of the MS-PW; and

FIG. 4 is a schematic diagram illustrating the networking according to one embodiment of the present invention.

### DETAILED DESCRIPTION OF THE EMBODIMENTS

The present invention is the grouping of PWs on a PSN to establish one-to-one mapping between the working PWG and the protective PWG, monitoring the state of a typical PW in the working PWG and the state of the corresponding protective PW in the protective PWG, and switching the services on the working PWG onto the protective PWG when a fault occurs in the working PWG but the protective PWG is in a normal state.

The present invention is now described in detail in conjunction with the accompanying drawings. A processing flowchart according to a particular embodiment of the method of the present invention is shown in FIG. 1, in which:

In block 1-1, PWs are grouped into a working PWG and a protective PWG corresponding to each other according to a preset criterion, such as the same source and destination, the same path, the same type, or the same QoS requirement.

According to an embodiment of the invention, first of all, the PWs on the PSN are required to be grouped. The process of the grouping of the PWs will now be explained in conjunction with particular network connections.

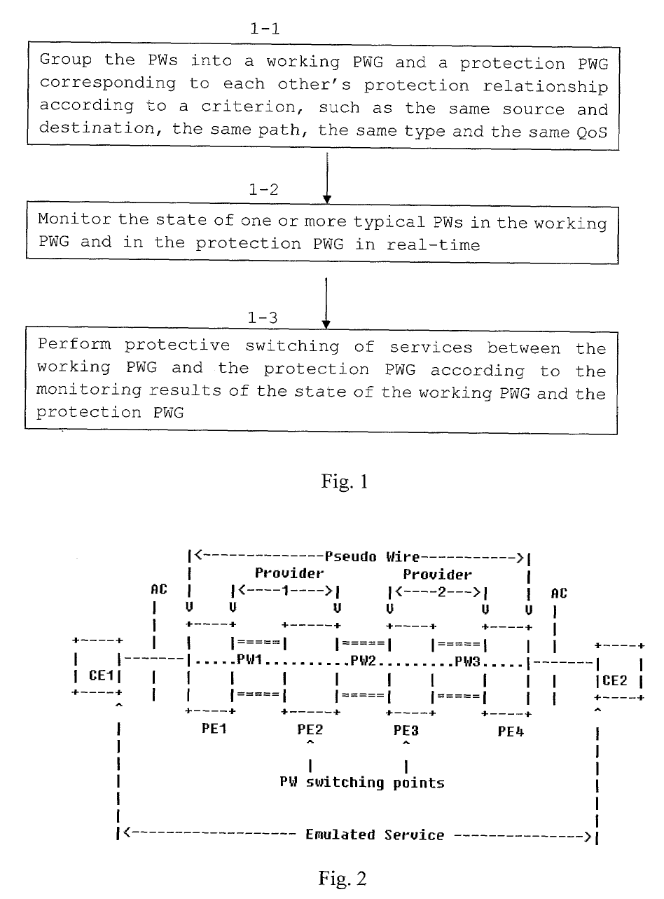

A schematic diagram illustrating an MS-PW reference model defined in the IETF draft standard draft-ietf-pwe3-ms-pw-requirements-00.txt is shown in FIG. 2, in which CE1 and CE2 are costumer edge network devices, AC is an access circuit, PW switching points are PW switching nodes, Emulated Service is an emulation service, Provider1 and Provider2 are network carriers, Provider1 and Provider2 can be the same carrier within an administrative domain. The edge-to-edge PWs can be implemented as multi-segment PWs.

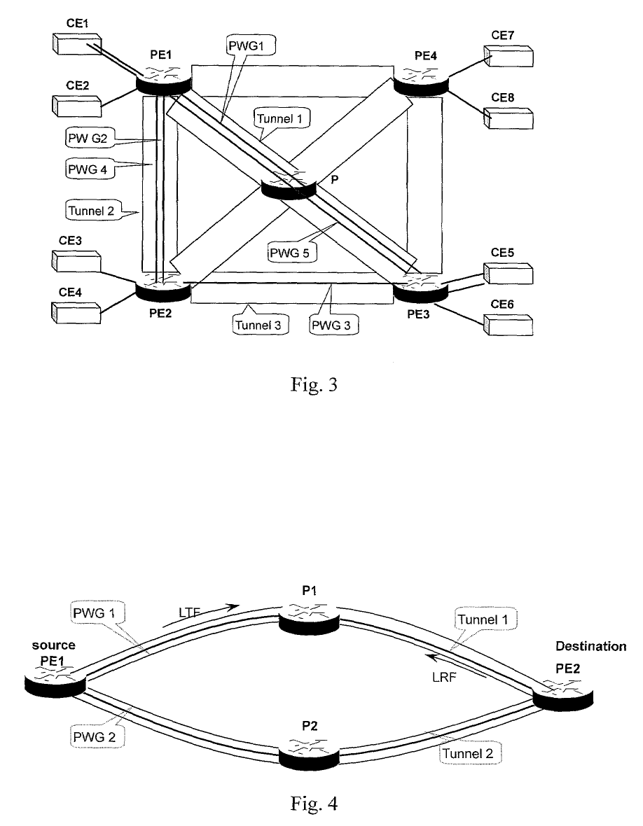

FIG. 3 is a schematic diagram illustrating the network connections in the reference model as shown in FIG. 2. The multi-segment PWs as shown in FIG. 3 belong to the same carrier network.

In the FIG. 3 illustrating the network connections, P is an inter-carrier network device, Tunnel1 runs from PE1 through the PSN network to PE3, Tunnel2 runs from PE1 through the PSN network to PE2, and Tunnel3 runs from PE2 through the PSN network to PE3.

PWG1 carried by Tunnel1 runs from PE1 directly to PE3. PWG2 and PWG3, carried by Tunnel2 and Tunnel3 respectively, compose multi-segment PWs and provide edge-to-edge protection for PWG1. PWG4 is from PE1 directly to PE2 and shares Tunnel2 with PWG2. PWG5 shares Tunnel1 with PWG1.

One or more PWs may be contained in the above-mentioned PWGs. Also, the PW in the working PWG and the protective PWG can be a single-segment PW or a multi-segment PW.

According to an embodiment of the invention, the above-mentioned PWGs need to be grouped. The grouping criterions can be the same source and destination, the same path, the same type and the same QoS requirement, or a criterion specified according to transmission requirements. One-to-one mapping is established between the working PWG (i.e., the main PWG) and the protective PWG (i.e., the backup PWG). For example, the above mapping is established between PWG5 and PWG1, between PWG2 or PWG4 plus PWG3 and PWG1, and the like. One-to-one mapping is established between the PWs in the working PWG and the PWs in the protection PWG according to an order in which the PWs are arranged in the two PWGs, respectively.

The PWs, when established, can be grouped according to the Group ID in the PW control signaling, which is defined in IETF draft-ietf-pwe3-control-protocol-17.txt 5.3.2.2. PW Grouping TLV.

In block 1-2, the state of one or more typical PWs in the working PWG and the protective PWG, such as the first PW in the two PWGs, one or more PWs carrying the most important service, or one or more PWs with the largest bandwidth, etc., is monitored in real-time.

After having been grouped, the PWs can be managed conveniently. The state of a certain PWG can be determined by the real-time monitoring of the state of one or more typical PWs in the PWG.

The PW state specified by the IETF draft standard draft-ietf-pwe3-iana-allocation-09.txt is as follows:

0×00000000—Pseudo Wire forwarding (clear all failures)

### 0×00000001—Pseudo Wire Not Forwarding

0×00000002—Local Attachment Circuit (ingress) Receive Fault
0×00000004—Local Attachment Circuit (egress) Transmit Fault
0×00000008—Local PSN-facing PW (ingress) Receive Fault (LRF)
0×00000010—Local PSN-facing PW (egress) Transmit Fault (LTF)

The above PW state can be transmitted either in an in-band mode or in an out-of-band mode in a control plane. 0×00000001 is an indication of a PW state that has not started the forwarding, which is generally a normal state (for instance, the PW forwarding is intentionally forbidden), and cannot constitute the PW protective switching condition. 0×00000002 and 0×00000004 are indications of the state of the Access Circuit (AC), and cannot constitute the PW protective switching condition. However, 0×00000008 and 0×00000010 are indications of a PW state in which receive faults and transmit faults occur, respectively, and can constitute the PW protective switching condition.

During the PW protective switching, it is also required to determine whether a PW service runs on the working PW (i.e. the main PW) or the protective PW (i.e., the backup PW). The PW state codes are defined as follows:

0×00000000—PW is in working path
0×10000000—PW is in protection path
0×00000001—PW is in working path
0×10000001—PW is in protection path
0×00000002—PW is in working path
0×10000002—PW is in protection path
0×00000004—PW is in working path
0×10000004—PW is in protection path
0×00000008—PW is in working path
0×10000008—PW is in protection path
0×00000000—PW is in working path
0×10000010—PW is in protection path

The above two kinds of state codes are logically overlaid according to a logical OR relationship.

When the system is running, the various PW state defined above are transmitted between the source PE and the destination PE in a periodic session, the period of which can be in a range of 10 ms˜10 s and will be generally set, but is not limited, to 5 s. When the state of the source PE or the destination PE is changing suddenly, e.g., from 0×00000000 to 0×00000008, or from 0×00000010 to 0×00000000, the state session of the PW will be started immediately, so as to ensure that the protective switching time will not exceed the maximum switching time allowed by the communications network services.

Generally, the PW is bidirectionally connected. A PW state is transmitted from PE1 to PE2, which detects the PW state and feeds it back to PE1.

The process of generating LTF (Local Transmit Fault) state and LRF (Local Receive Fault) state is now explained in conjunction with a particular embodiment. As shown in FIG. 4, PWG1 is a working PWG; PWG2 is a protective PWG; PE1 is a source PE and PE2 is a destination PE.

The LTF can be generated by a transmit fault or an interface fault occurring in the PW forwarder on PE1 or the server layer of the PW. For example, the generation of the LTF can be triggered by a tunnel transmit fault, which can be a fault occurring in the tunnel, or a fault occurring in other server layers, such as Ethernet, Generic Framing Process (GFP) and SDH/SONET.

The LRF can be generated by a receive fault or an interface fault occurring in the PW forwarder on PE2 or the server layer of the PW. For example, the generation of the LRF can be triggered by a tunnel receive fault, which can be a fault occurring in the tunnel, or a fault occurring in other server layers, such as Ethernet, GFP and SDH/SONET.

In block 1-3, if it is determined that the protective switching condition is met according to the monitoring results of the state of the working PWG and the protective PWG, protective switching between the working PWG and the protective PWG are performed on services.

If one or more typical PWs in a working PWG are detected to be in the LTF or LRF state, and the PWs in the corresponding protective PWG is in a normal state, it is determined that the protective switching condition is met, and now fast protective switching can be performed for the working PWG.

Similarly, if one or more typical PWs in a protective PWG are detected to be in the LTF or LRF state, and the PWs in the corresponding working PWG is in a normal state, fast protective switching can be performed for the protective PWG

The PW protective switching mechanism acts as a state machine for performing protective switching on the source PE and the destination PE. The protective switching performed between the working PWG and the protective PWG can be 1+1, 1:1 or 1:N, unidirectional or bidirectional, recoverable or unrecoverable, manual, or of a mode defined by APS (Automatic Protective Switching) protocols. Definitions of these modes can be referred to the ITU-T recommendation G.873, G.873.1.

For example, in the networking diagram of FIG. 4, after PE2 has received the LTF transmitted through a state session by PE1, it is determined that a fault has occurred in PWG1, and then the above-described protective switching mechanism is started so that the services on PWG1 are switched onto PWG2.

Similarly, when PE2 detects that the received state has changed to LRF, it is determined that a fault has occurred in PWG1, and then the above-mentioned protective switching mechanism is started such that the services on PWG1 are switched onto PWG2, and a LRF state message is transmitted to PE1 through the state session between PE1 and PE2.

Alternatively, the PW protective switching can be triggered by VCCV. VCCV is transmitted between the source PE and the destination PE periodically. Link interruption or PE forwarding faults, e.g., software or hardware faults of the forwarder or physical faults of the interface, will result in a case in which a normal session of the VCCV has not been established within a prescribed period of time. In this case, the protective switching condition is also met. Accordingly, the PE having detected such an abnormal state starts the above-described protective switching mechanism. The VCCV can be performed either for a PW or for a PWG. The definition of the VCCV is specified in draft-ietf-pwe3-vccv-04.txt.

An embodiment of the invention also provides a device for protective switching of PWs on a PSN, comprising:

a grouping unit for grouping PWs on a PSN into a working PWG and a protective PWG corresponding to each other according to a preset criterion, one-to-one mapping being established between the PWs in the working PWG and the PWs in the protective PWG according to an order in which the PWs are arranged in the two PWGs respectively, the preset criterion including, but not limited to, the same source and destination, the same path, the same type and the same QoS requirement, or a criterion specified according to transmission requirements;

a PW state monitoring unit for monitoring the state of the working PWG and the protective PWG, and for sending signals to the protective switching unit when it is determined that a protective switching condition is met; and

a protective switching unit for performing on services the protective switching between the working PWG and the protective PWG according to the received signals.

The PW in the working PWG and the protective PWG is a single-segment PW or a multi-segment PW. One or more PWs are contained in the working PWG and the protective PWG.

Moreover, the protective switching performed between the working PWG and the protective PWG can be 1+1, 1:1 or 1:N, unidirectional or bidirectional, recoverable or unrecoverable, manual, or of a mode defined by APS (Automatic Protective Switching) protocols.

It is apparent to those skilled in the art that various modifications can be made to the present invention without departing from the spirit or scope of the invention. Therefore, it is intended that the present invention covers such modifications provided they come within the scope of the appended claims and their equivalents.

What is claimed is:

1. A method for protective switching of pseudo-wires on a Packet Switching Network, comprising:
grouping the pseudo-wires on a Packet Switching Network into a working Pseudo-Wire group and a protective Pseudo-Wire group corresponding to each other, and monitoring the state of the working Pseudo-Wire group and the protective pseudo-wire group, and performing on services the protective switching between the working pseudo-wire group and the protective pseudo-wire group when it is determined that a protective switching condition is met.

2. The method according to claim 1, wherein one-to-one mapping is established between the pseudo-wires in the working pseudo-wire group and the pseudo-wires in the protective pseudo-wire group according to an order in which the pseudo-wires are arranged in the two pseudo-wire groups, respectively.

3. The method according to claim 1, wherein the preset criterion includes, but is not limited to, the same source and destination, the same path, the same type and the same QoS requirement, or a criterion specified according to transmission requirements.

4. The method according to claim 1, wherein the pseudo-wire in the working pseudo-wire group and the protective pseudo-wire group is a single-segment pseudo-wire or a multi-segment pseudo-wire.

5. The method according to claim 1, wherein one or more pseudo-wires are contained in the working pseudo-wire group and the protective pseudo-wire group.

6. The method according to claim 1, wherein it is determined that the protective switching condition is met if a monitored pseudo-wire in a pseudo-wire group is in Local Transmit Fault state and/or Local Receive Fault state, and the pseudo-wire corresponding to the monitored pseudo-wire in the other pseudo-wire group is in a normal state.

7. The method according to claim 6, wherein the Local Transmit Fault state and the Local Receive Fault state can be generated by a transmit fault or an interface fault occurring in the pseudo-wire forwarder on a source provider edge or a destination provider edge, as well as the server layer of the pseudo-wire.

8. The method according to claim 1, wherein it is determined that the protective switching condition is met, if a normal session of the Virtual Circuit Continuity Verification performed for the monitored pseudo-wire in a pseudo-wire group has not been established within a prescribed period of time, and the pseudo-wire corresponding to the monitored pseudo-wire in the other pseudo-wire group is in a normal state.

9. The method according to claim 1, wherein the protective switching performed between the working pseudo-wire group and the protective pseudo-wire group can be 1+1, 1:1 or 1:N, unidirectional or bidirectional, recoverable or unrecoverable, manual, or of a mode defined by Automatic Protective Switching protocols.

10. A device for protective switching of pseudo-wires on a Packet Switching Network, comprising:
a grouping unit for grouping pseudo-wires on a Packet Switching Network into a working pseudo-wire group and a protective pseudo-wire group corresponding to each other;
a pseudo-wire state monitoring unit for monitoring the state of the working pseudo-wire group and the protective pseudo-wire group, and for sending signals to the protective switching unit when it is determined that a protective switching condition is met; and
a protective switching unit for performing on services the protective switching between the working pseudo-wire group and the protective pseudo-wire group according to the received signals.

11. The device according to claim 10, wherein one-to-one mapping is established between the pseudo-wires in the working pseudo-wire group and the pseudo-wires in the protective pseudo-wire group according to an order in which the pseudo-wires are arranged in the two pseudo-wire groups respectively.

12. The device according to claim 10, wherein the preset criterion includes, but is not limited to, the same source and destination, the same path, the same type and the same QoS requirement, or a criterion specified according to transmission requirements.

13. The device according to claim 10, wherein the pseudo-wire in the working pseudo-wire group and the protective pseudo-wire group is a single-segment pseudo-wire or a multi-segment pseudo-wire.

14. The device according to claim 10, wherein one or more pseudo-wires are contained in the working pseudo-wire group and the protective pseudo-wire group.

15. The device according to claim 10, wherein the protective switching performed between the working pseudo-wire group and the protective pseudo-wire group can be 1+1, 1:1 or 1:N, unidirectional or bidirectional, recoverable or unrecoverable, manual, or of a mode defined by APS protocols.

16. The method according to claim 1, wherein the monitoring comprises monitoring in real-time the state of one or more typical PWs in the working PWG and the protective PW.
